(19) United States
(12) Patent Application Publication
(10) Pub. No.: US 2014/0347859 A1
(43) Pub. Date: Nov. 27, 2014

(54) Thermally efficient OGC lamp

(71) Applicant: Wenchang Fan, Yuyao City (CN)

(72) Inventor: Wenchang Fan, Yuyao City (CN)

(21) Appl. No.: 13/920,131

(22) Filed: Jun. 18, 2013

(30) Foreign Application Priority Data
May 23, 2013 (CN) 201310196313.4

(51) Int. Cl. F21V 29/00; F21V 23/00; F21V 31/00; F21K 99/00

(52) U.S. Cl. CPC F21V 29/244; F21K 9/1355; F21V 23/009; F21V 29/248; F21V 31/005; F21Y 2101/02
USPC 362/267

(57) ABSTRACT

A thermally efficient OGC lamp includes a positive terminal; a negative terminal; a connecting member formed with the negative terminal; a circuit board disposed substantially within the negative terminal; a housing formed with the connecting member; a thermally efficient element filled in the housing; a sealing member disposed on the connecting member; a lens disposed on a bottom of the housing and being distal the connecting member; and a plurality of integrated circuits disposed in the lens for emitting light. The integrated circuits are electrically connected to the circuit board. The circuit board is electrically connected to both the positive terminal and the negative terminal. The thermally efficient element is either oil or wax.

### BACKGROUND OF THE INVENTION

1. Field of the Invention

The invention relates to lamps and more particularly to a thermally efficient OGC (oil, glass, and chips) lamp.

2. Description of Related Art

Light emitting diodes (LEDs) are renowned for their long useful life and ability to resist shock. LED has the advantages of efficiency, compactness, quick on/off time, prolonged lifetime, and shock resistance. There are a number of commercially available quality LED lamps. For example, 20 W white LED lamp having a luminous flux of 700 Im and a luminance efficacy of 34 Im/W is produced by Edison Inc. A 100 W white LED having a luminous flux of 600 Im and a luminance efficacy of 60 Im/W is produced by Edison Inc.

It has been found necessary to multiply the number of LED units to increase light output. However, this increase in number has also increased the amount of heat generated. Metal heat sink is typically provided as means for heat elimination. However, its performance is low, it is somewhat bulky, and its cost is relatively expensive.

Thus, how to effectively eliminate heat generated by a lit LED in a cost effective manner is a great issue to address.

### SUMMARY OF THE INVENTION

It is therefore one object of the invention to provide a t light source comprising a positive terminal; a negative terminal; a connecting member formed with the negative terminal; a circuit board disposed substantially within the negative terminal; a housing formed with the connecting member; a thermally efficient means filled in the housing;

a sealing member disposed on the connecting member; a lens disposed on a bottom of the housing and being distal the connecting member; and a plurality of integrated circuits disposed in the lens for emitting light; wherein the integrated circuits are electrically connected to the circuit board; and wherein the circuit board is electrically connected to both the positive terminal and the negative terminal.

The above and other objects, features and advantages of the invention will become apparent from the following detailed description taken with the accompanying drawings.

### BRIEF DESCRIPTION OF THE DRAWINGS

FIG. 1 is a schematic side elevation of a thermally efficient OGC lamp according to a third preferred embodiment of the invention, the thermally efficient means being oil; and

FIG. 2 is a schematic side elevation of a thermally efficient OGC lamp according to a second preferred embodiment of the invention, the thermally efficient means being wax.

### DETAILED DESCRIPTION OF THE INVENTION

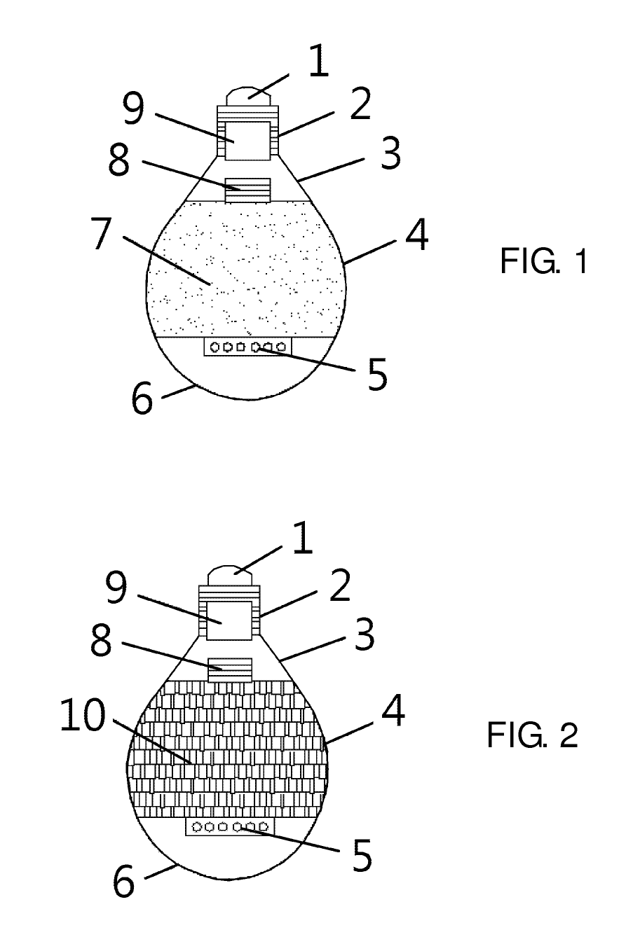

Referring to FIG. 1, a lamp in accordance with a third preferred embodiment of the invention comprises the following components as discussed in detail below.

A positive terminal 1 is served as a contact. An externally threaded negative terminal 2 is served as a base. An inverted funnel shaped connecting member 3 is formed with the negative terminal 2. A circuit board 9 is disposed substantially within the negative terminal 2. A housing 4 is formed with the connecting member 3. A thermally efficient means 7 is filled in the housing 4. A sealing member 8 is disposed on the connecting member 3 and contacts a joining edge of the connecting member 3 and the housing 4. A person may open the sealing member 8 to fill the thermally efficient means 7 into the housing 4. A bowl shaped lens 6 is disposed on a bottom of the housing 4. A plurality of integrated circuits (i.e., chips) 5 are disposed in the lens 6 and are electrically connected to the circuit board 9 which is in turn electrically connected to both the positive terminal 1 and the negative terminal 2.

Preferably, the housing 4 is formed of glass or ceramic.

Preferably, the thermally efficient means 7 is oil.

Preferably, the lens 6 is formed of glass or plastic.

It is envisaged by the invention that the glass or ceramic housing 4 is provided for eliminating the generated heat and the oil 7 is for further aiding the elimination of generated heat.

The lamp is thus called OGC lamp from acronym of its major components oil, glass, and chips.

Lighting principle of the invention is described in detail below. After mounting the positive terminal 1 and the negative terminal 2 in a socket, electric current is supplied from the circuit board 9 to the chips 5 for illumination. Heat generated by the chips is substantially eliminated by both the oil 7 and the housing 4, thereby greatly increasing illumination. It is found that temperature of the chips 5 is kept between 45° C. and 55° C. and it is the preferred temperature range for prolonging the useful life of the chips 5 and thus the lamp.

Conventionally, a substrate of the chips 5 is made of metal or ceramic and it can greatly decrease illumination.

Advantageously, a substrate of the chips 5 is formed of transparent glass and it can increase illumination of the chips by 30% to 50%.

Referring to FIG. 2, a lamp in accordance with a second preferred embodiment of the invention is shown. The characteristics of the second preferred embodiment are substantially the same as that of the first preferred embodiment except the following: The oil 7 is replaced with wax 10.

While the invention has been described in terms of preferred embodiments, those skilled in the art will recognize that the invention can be practiced with modifications within the spirit and scope of the appended claims.

What is claimed is:

1. A light source comprising:
a positive terminal;
a negative terminal;
a connecting member formed with the negative terminal;
a circuit board disposed substantially within the negative terminal;
a housing formed with the connecting member;
thermally efficient means filled in the housing;
a sealing member disposed on the connecting member;
a lens disposed on a bottom of the housing and being distal the connecting member; and
a plurality of integrated circuits disposed in the lens for emitting light;
wherein the integrated circuits are electrically connected to the circuit board; and
wherein the circuit board is electrically connected to both the positive terminal and the negative terminal.

2. The light source of claim 1, wherein the negative terminal is externally threaded.

3. The light source of claim 1, wherein the housing is formed of glass.

4. The light source of claim 1, wherein the housing is formed of ceramic.

5. The light source of claim 1, wherein the thermally efficient means is oil.

6. The light source of claim 1, wherein the thermally efficient means is wax.

7. The light source of claim 1, wherein the lens is formed of glass.

8. The light source of claim 1, wherein the lens is formed of plastic.
